(19) United States
(12) Patent Application Publication
(10) Pub. No.: US 2025/0132949 A1
(43) Pub. Date: Apr. 24, 2025

(54) TRANSMITTING/RECEIVING DEVICE FOR SELECTIVELY WAKING UP A SUBSCRIBER STATION OF A SERIAL BUS SYSTEM AND METHOD FOR SELECTIVELY WAKING UP A SUBSCRIBER STATION IN A SERIAL BUS SYSTEM

(71) Applicant: Robert Bosch GmbH, Stuttgart (DE)

(72) Inventors: Arthur Mutter, Neuhausen (DE); Florian Hartwich, Reutlingen (DE)

(21) Appl. No.: 18/888,417

(22) Filed: Sep. 18, 2024

(30) Foreign Application Priority Data
Oct. 19, 2023 (DE) 10 2023 210 271.4

(51) Int. Cl. H04L 12/40; H04L 25/49; H04L 67/12

(52) U.S. Cl. CPC H04L 12/40039; H04L 25/4902; H04L 67/12; H04L 2012/40215

(57) ABSTRACT

A transmitting/receiving device for selectively waking up a subscriber station of a serial bus system. The transmitting/receiving device has: a transmitting module for transmitting a transmission signal, which is created for communication in the bus system based on a frame, as an analog signal to a bus; a receiving module for receiving an analog signal from the bus and for generating a digital reception signal from the analog signal received from the bus; and a wake-up module for waking up the subscriber station after the subscriber station has been put to sleep to save energy, wherein the wake-up module is designed to serially carry out at least two different evaluations in order to decide whether or not the digital reception signal corresponds to a wake-up frame which gives instructions to activate the transmitting module to wake up the subscriber station.

### CROSS REFERENCE

The present application claims the benefit under 35 U.S.C. § 119 of German Patent Application No. DE 10 2023 210 271.4 filed on Oct. 19, 2023, which is expressly incorporated herein by reference in its entirety.

### FIELD

The present invention relates to a transmitting/receiving device for selectively waking up a subscriber station of a serial bus system and to a method for selectively waking up a subscriber station in a serial bus system.

### BACKGROUND INFORMATION

Bus systems are used in many fields of technology for communication between technical devices, such as sensors and controllers. In some bus systems, technical devices are intended to communicate with one another, where applicable being able to switch as required between different standards and/or rates for the data transmission or communication between the subscriber stations of the bus system.

Currently, Classical CAN and/or CAN FD, which are both standardized in the international standard ISO 11898-1:2015, are used for communication between devices in vehicles and/or in other technical devices. CAN XL can also be used, which is specified in CiA610-1 and is currently being integrated into ISO11898-1. In such a CAN-bus-based communication, a frame is used for generating a transmission signal, the frame being divided into an arbitration phase and a data phase. In the arbitration phase, negotiations are held between the subscriber stations of the bus system as to which of the subscriber stations of the bus system will be given exclusive access to the bus in the following data phase and then be allowed to send its data to the bus. In CAN FD and in CAN XL, the bits of the transmission signal are generated with a shorter bit time in the data phase than in the arbitration phase—in other words, with a higher bit rate—and transmitted to the bus. With the aid of SIC and SIC XL transmitting/receiving devices, which are also called transceivers, bit rates up to 8 Mbit/s are possible in the data phase with CAN FD and bit rates up to 20 Mbit/s with CAN XL. On the other hand, the bit rate remains at approximately 500 kbit/s in the arbitration phase in order to make arbitration possible.

In order to reduce the energy consumption of a system, for example a vehicle, etc., subscriber stations on a CAN bus that are not currently needed should be put to sleep and woken up again when required. Wake-up can either take place with a predetermined wake-up pattern that all subscriber stations on the bus recognize and, as a result, participate in the communication on the bus again. Or the wake-up signal is transmitted by a management subscriber station and is designed in such a way that at least individual subscriber stations of the bus can be woken up individually or selectively. Usually, wake-up is carried out by means of a CAN transmitting/receiving device (transceiver) which generates such a wake-up signal with the aid of a Classical CAN frame. This is described in the international standard ISO 11898-2:2016.

Selective wake-up is possible in a resource-efficient implementation with Classical CAN frames and the clock source that can be used for them, which has a high tolerance and is therefore cost-effective.

However, a problem arises when bit rates of more than 8 Mbit/s are to be used in the bus system, which requires the use of transmission signal(s) based on CAN XL frames. However, for such bit rates, CAN XL must be operated with SIC XL transceivers and error signaling must be deactivated for CAN XL communication. CAN XL thus automatically loses compatibility with CAN FD and Classical CAN. As a result, communication on the bus is only possible using CAN XL. This has the disadvantage that the selective wake-up with Classical CAN frames is no longer usable.

Another problem is that the use of a CAN XL frame for selective wake-up would be very expensive in comparison to a Classical CAN frame. The reason for this is the precise clock required for CAN XL and the significantly higher complexity of the CAN XL protocol.

### SUMMARY

An object of the present invention is to provide a transmitting/receiving device for selectively waking up a subscriber station of a serial bus system and a method for selectively waking up a subscriber station in a serial bus system, which solve the aforementioned problems. In particular, a transmitting/receiving device for selectively waking up a subscriber station of a serial bus system and a method for selectively waking up a subscriber station in a serial bus system are to be provided, in which selective wake-up of the individual subscriber stations is possible in a simple and cost-effective manner for all (currently) possible bit rates, even if different communication standards and bit rates are used in the arbitration phase and data phase.

This object is achieved by a transmitting/receiving device for selectively waking up subscriber stations of a serial bus system having certain features of the present invention. According to an example embodiment of the present invention, the transmitting/receiving device has a transmitting module for transmitting a transmission signal, which is created for communication in the bus system on the basis of a frame, as an analog signal to the bus of the bus system, a receiving module for receiving an analog signal from the bus of the bus system and for generating a digital reception signal from the analog signal received from the bus, and a wake-up module for waking up the subscriber station after the subscriber station has been put to sleep to save energy, wherein the wake-up module is designed to serially carry out at least two different evaluations in order to decide whether or not the digital reception signal corresponds to a wake-up frame which gives instructions to activate the transmitting module to wake up the subscriber station, and wherein, for the decision as to whether or not the digital reception signal corresponds to the wake-up frame, the wake-up module is designed to decode the digital reception signal in a predetermined region according to a different format than the predetermined region was encoded in the transmission signal.

The design of the described transmitting/receiving device of the present invention makes it possible that the selective wake-up of at least one subscriber station of a serial bus system can take place with a design that can be used independently of the bit rate possible in the bus system.

The described transmitting/receiving device of the present invention can thus use the same frame in the bus system at bit rates below 8 Mbit/s and at bit rates of more than 8 Mbit/s.

Switching the type of selective wake-up is thus also not necessary in the case of an increased bit rate.

Selective wake-up can be implemented simply and therefore cost-effectively because the described transmitting/receiving device does not have to be able to decode the short bits of the CAN XL data phase individually.

Very advantageously, the costs for the described transmitting/receiving device (wake-up transceiver) remain low. One reason for this is that the complexity of the wake-up method carried out by the transmitting/receiving device approximately corresponds to the complexity in the case of Classical CAN. Another reason for this is that a clock source with a high tolerance, i.e., low accuracy, is sufficient for the transmitting/receiving device.

CAN XL can thus be operated in the data phase with SIC XL transmitting/receiving devices (transceivers) for high bit rates of up to 20 Mbit/s and error signaling can be deactivated for CAN XL. Nevertheless, in this case, the previously described option for cost-effective selective wake-up is available.

In addition, the previously described technology of the transmitting/receiving device (wake-up transceiver) according to the present invention can also be used for communication with CAN FD. This also applies if the conventional method for generating a wake-up signal with the aid of a Classical CAN frame, which is described in the international standard ISO 11898-2:2016, can be used with CAN FD.

As a whole, the bus system can thus be operated very energy-efficiently and thus cost-effectively due to the high bit rate that can be used in the data phase and the resulting increased possibility of selectively putting individual subscriber stations of the bus system to sleep.

The subscriber station described also makes it possible for at least two subscriber stations to be present in the bus system, which send messages to the bus according to different CAN standards. For example, in addition to two CAN XL subscriber stations, at least one other subscriber station which transmits messages to the bus according to another/a different CAN standard can thus also be present in the bus system.

Advantageous further embodiments of the subscriber station are disclosed herein.

According to an example embodiment of the present invention, for decoding in the different format, the wake-up module may be designed to decode the digital reception signal in at least a portion of the predetermined region by using at least a first bit duration which is a multiple of a second bit duration with which the predetermined region was encoded in the transmission signal.

According to an example embodiment of the present invention, for decoding in the different format, the wake-up module may be designed to carry out pulse width modulation decoding in at least a portion of the predetermined region.

According to one exemplary embodiment of the present invention, the predetermined region comprises a preamble and a pulse-width-modulated region, wherein the preamble is designed to mark the beginning of the pulse-width-modulated region.

According to one exemplary embodiment of the present invention, the predetermined region comprises a field for a data length code, a data field corresponding to the data length code, and a check field for checking the correctness of at least a portion of the predetermined region, wherein, for evaluating the content of the fields of the predetermined region, the wake-up module is designed to carry out decoding in the predetermined region.

The frame can be divided into a first communication phase and a subsequent second communication phase so that, in the first communication phase, the subscriber stations can negotiate which of the subscriber stations of the bus system will be given at least temporarily exclusive, collision-free access to the bus in the subsequent second communication phase, wherein the predetermined region is arranged in the second communication phase of the frame, in particular in a data field of the frame.

According to an example embodiment of the present invention, the wake-up module is, for example, designed, before decoding the predetermined region, to check at least one of the wake-up conditions in order to decide whether or not the digital reception signal corresponds to the wake-up frame, wherein the wake-up module is designed to switch the receiving module from a first operating mode to a second operating mode, which differs from the first operating mode, if the at least one wake-up condition is present.

The at least one wake-up condition may be a priority ID which determines with which temporal priority the frame could be transmitted to the bus.

The at least one wake-up condition may be a single bit which is arranged directly after the priority ID in the received frame (460).

In one example embodiment of the present invention, the received frame is a CAN XL frame and the single bit is the RRS bit.

According to one exemplary embodiment of the present invention, the wake-up module comprises a decoding block for decoding the reception signal output by the receiving module on the basis of the frame which was used to create the analog signal on the bus of the bus system (1), and an evaluation block for evaluating the result output by the decoding block as to whether or not the digital reception signal corresponds to the wake-up frame.

The above-described transmitting/receiving device of the present invention may also have a configuration block for storing at least one of the at least two wake-up conditions, wherein the evaluation block is designed to carry out its evaluation by accessing the configuration block, and wherein the evaluation block is designed to generate a signal for activating the power supply for the transmitting module if the digital reception signal corresponds to the wake-up frame.

The above-described transmitting/receiving device of the present invention may be part of a subscriber station which also comprises a communication control device which is designed to sample and evaluate the reception signal generated by the transmitting/receiving device, according to a predetermined frame, wherein the communication control device is designed to control communication of the subscriber station with at least one other subscriber station of the bus system and to evaluate the reception signal, for which the bit time in a first communication phase can differ from a bit time in a second communication phase.

It is possible that the communication control device is designed, in the first communication phase, to negotiate with the other subscriber stations as to which of the subscriber stations of the bus system will be given at least temporarily exclusive, collision-free access to the bus in the subsequent second communication phase.

The above-described (first) subscriber station of the present invention can be designed to transmit a wake-up frame to the bus of the bus system in order to selectively wake up at least one other (second) subscriber station of the bus system after it has been put to sleep.

The above-described subscriber stations of the present invention can be a first and at least one second subscriber station of a bus system, which also comprises a bus, wherein the at least one second subscriber station is connected to the first subscriber station via the bus (40) in such a way that the subscriber stations can communicate with one another serially.

The aforementioned object may also be achieved by a method for selectively waking up a subscriber station in a serial bus system according to features of the present invention. According to an example embodiment of the present invention, the method is performed by means of a transmitting/receiving device which comprises a transmitting module, a receiving module and a wake-up module, wherein the method comprises the steps of transmitting, by means of the transmitting module, a transmission signal, which is created for communication in the bus system on the basis of a frame, as an analog signal to the bus of the bus system; receiving, by means of the receiving module, the analog signal from the bus of the bus system; generating, by means of the receiving module, a digital reception signal from the analog signal received from the bus;

waking up, by means of the wake-up module, the subscriber station after the subscriber station has been put to sleep to save energy, wherein the wake-up module serially carries out at least two different evaluations in order to decide whether or not the digital reception signal corresponds to a wake-up frame which gives instructions to activate the transmitting module to wake up the subscriber station, and wherein, for the decision as to whether or not the digital reception signal corresponds to the wake-up frame, the wake-up module decodes the digital reception signal in a predetermined region according to a different format than the predetermined region was encoded in the transmission signal.

The method of the present invention offers the same advantages as those mentioned above with respect to the transmitting/receiving device of the present invention.

Further possible implementations of the present invention also include combinations, even those not explicitly mentioned, of features or embodiments described above or below with respect to the exemplary embodiments. In this case, a person skilled in the art will also add individual aspects as improvements or additions to the relevant basic form of the present invention.

### BRIEF DESCRIPTION OF THE DRAWINGS

The present invention is described in more detail below with reference to the figures and on the basis of exemplary embodiments.

FIG. 1 shows a simplified block diagram of a bus system according to a first exemplary embodiment of the present invention.

FIG. 2 shows the format of CAN FD frames according to the aforementioned standard ISO 11898-1:2015 for a message which can be transmitted from a transmitting/receiving device for a subscriber station of the bus system according to the first exemplary embodiment of the present invention.

FIG. 3 shows the format of CAN XL frames according to the aforementioned standard CiA610-1 for a message which can be transmitted from a transmitting/receiving device for a subscriber station of the bus system according to the first exemplary embodiment of the present invention as an alternative to the CAN FD frame of FIG. 2.

FIG. 4 shows a simplified schematic block diagram of a subscriber station of the bus system according to the first exemplary embodiment of the present invention.

FIG. 5 shows a time profile of bus signals CAN_H and CAN_L at the subscriber station according to the first exemplary embodiment of the present invention.

FIG. 6 shows a time profile of a differential voltage VDIFF of bus signals CAN_H and CAN_L at the subscriber station according to the first exemplary embodiment of the present invention.

FIG. 7 is a more detailed block circuit diagram of the subscriber station of FIG. 4 for illustrating the structure of its wake-up module.

FIG. 8 shows an example of a portion of a digital transmission signal which a management subscriber station as the first subscriber station creates over time on the basis of a wake-up frame which is intended for waking up a second subscriber station of the bus system.

FIG. 9 shows a portion of a reception signal which the second subscriber station of the bus system decodes from a signal that is transmitted via the bus and is based on the transmission signal of FIG. 8.

FIG. 10 is a flow chart of a method that can be executed in the bus system according to the first exemplary embodiment of the present invention.

FIG. 11 shows a wake-up frame according to a second exemplary embodiment of the present invention.

FIG. 12 shows a wake-up frame according to a fourth exemplary embodiment of the present invention.

In the figures, identical or functionally identical elements are given the same reference signs unless otherwise indicated.

### DETAILED DESCRIPTION OF EXAMPLE EMBODIMENTS

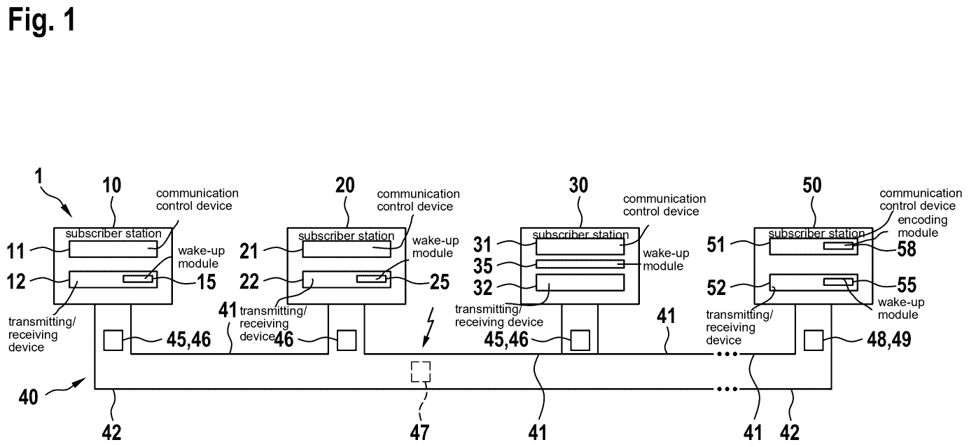

FIG. 1 shows an example of a bus system 1, which is in particular fundamentally designed for a CAN bus system, a CAN FD bus system, a CAN XL bus system, and/or modifications thereof, as described below. The bus system 1 can be used in a vehicle, in particular a motor vehicle, an aircraft, etc., or in a hospital, etc.

In FIG. 1, the bus system 1 has a plurality of subscriber stations 10, 20, 30, 50, which are each connected to a bus 40 with a first bus wire 41 and a second bus wire 42. The bus wires 41, 42 can also be referred to as CAN_H and CAN_L and are used for electrical signal transmission after the coupling-in of the dominant levels or generation of recessive levels or other levels for a signal in the transmission state. Messages 45, 46 in the form of signals can be transmitted serially between the individual subscriber stations 10, 20, 30, 50 via the bus 40. If an error occurs during communication on the bus 40, as shown by the jagged black block arrow in FIG. 1, an error frame 47 with an error flag and an error delimiter can optionally be transmitted. The subscriber stations 10, 20, 30 of FIG. 1 are, for example, control devices, sensors, display devices, etc. of a motor vehicle or of another technical system.

The subscriber station 50 may also be referred to as a manager subscriber station or manager node or selective-wake-up subscriber station. The subscriber station 50 is also designed to transmit a wake-up frame 48 for selectively waking up one of the subscriber stations 10, 20, 30 via the bus 40 as required. The wake-up frame 48 can also be abbreviated as WUF. For encoding the wake-up frame 48, the subscriber station 50 can have an encoding module 58. Optionally, the subscriber station 50 is also designed to transmit a put-to-sleep frame 49 for selectively putting one of the subscriber stations 10, 20, 30 to sleep via the bus 40 as required.

As shown in FIG. 1, the subscriber station 10 has a communication control device 11, a transmitting/receiving device 12, and a wake-up module 15. The subscriber station 20 has a communication control device 21, a transmitting/receiving device 22, and a wake-up module 25. The subscriber station 30 has a communication control device 31, a transmitting/receiving device 32, and a wake-up module 35. The subscriber station 50 has a communication control device 51, a transmitting/receiving device 52, and a management module 55. The transmitting/receiving devices 12, 22, 32, 52 of the subscriber stations 10, 20, 30, 50 are each directly connected to the bus 40, even if this is not illustrated in FIG. 1.

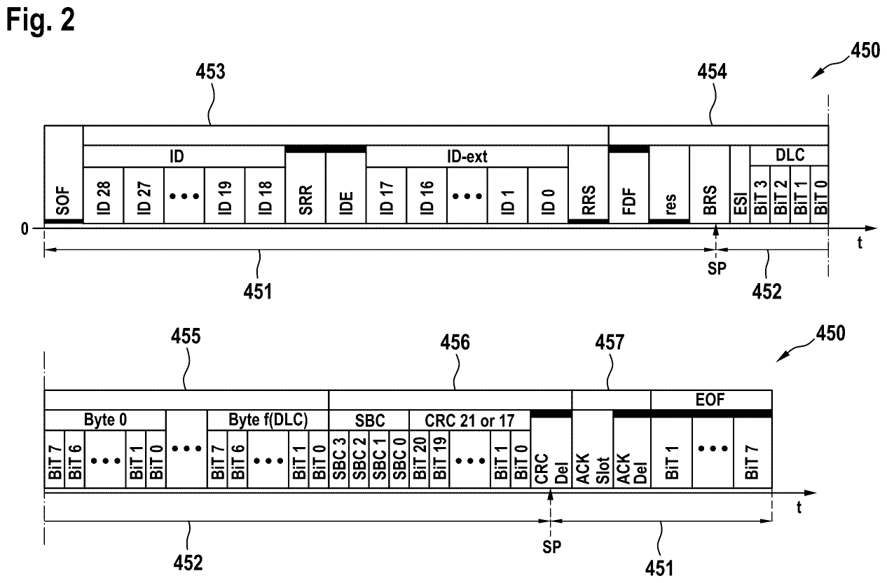

The communication control devices 11, 21, 31, 51 are each used for controlling a communication of the respective subscriber station 10, 20, 30, 50 via the bus 40 with at least one other subscriber station of the subscriber stations 10, 20, 30, 50 connected to the bus 40. For this purpose, the communication control devices 11, 31 create and/or read first messages 45 which are, for example, CAN FD messages 45. The CAN FD messages 45 are structured on the basis of a CAN FD format, which is described in more detail with reference to FIG. 2.

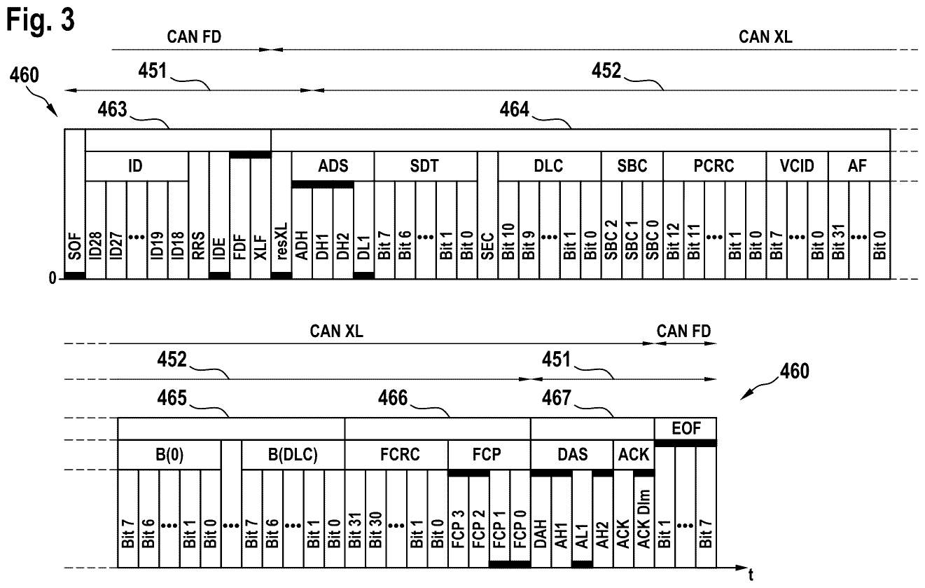

The communication control devices 11, 31, 51 may also be designed to provide or receive a CAN FD message 45 or a CAN XL message 46 to or from the associated transmitting/receiving device 12, 32, 52 as required. The CAN XL messages 46 are formed on the basis of a CAN XL format, which is described in more detail with reference to FIG. 3. The communication control devices 11, 31, 51 thus create and read a first message 45 or a second message 46, wherein the first and second messages 45, 46 differ in their data transmission standard, namely, CAN FD or CAN XL in this case.

The communication control device 21 can be designed as a conventional CAN controller according to ISO 11898-1:2015, i.e., as a CAN FD-tolerant Classical CAN controller or a CAN FD controller. The communication control device 21 creates and reads first messages 45, for example CAN FD messages 45. In the case of the CAN FD messages 45, a number of 0 to 64 data bytes can be included, which are in addition transmitted at a significantly faster data rate than in the case of a Classical CAN message. In particular, the communication control device 21 is designed as a conventional CAN FD controller.

The transmitting/receiving device devices 12, 32, 52 can be designed to provide or receive messages 45 according to the CAN FD format or messages 46 according to the CAN XL format to or from the associated communication control device 11, 31, 52 as required. In addition, the wake-up modules 15, 35 are present, which are described in more detail below.

The transmitting/receiving device 22 can be designed as a conventional CAN transmitting/receiving device according to ISO 11898-1:2015 or a CAN FD transmitting/receiving device. In addition, the wake-up module 25 is present, which can be designed according to the international standard ISO 11898-2:2016, as explained in more detail below.

The wake-up modules 15, 35 can also be designed to receive and read a wake-up frame designed according to the international standard ISO 11898-2:2016.

With the subscriber stations 10, 30, 50, formation and then transmission of messages 46 with the CAN XL format and the reception of such messages 46 can be implemented.

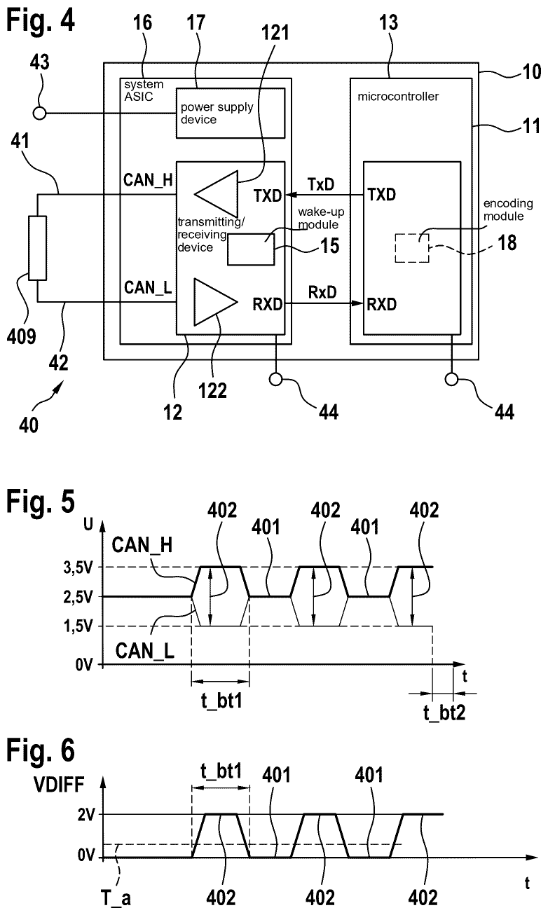

FIG. 2 shows a frame 450 created by one of the subscriber stations 10, 20, 30, 50 for a message 45 with up to 64 data bytes in the CAN FD format FEFF. The CAN FD frame 450 is provided by one of the communication control devices 11, 21, 31, 51, namely encoded in a digital transmission signal TxD (FIG. 4), to the associated transmitting/receiving device 12, 22, 32, 52 for transmission to the bus 40.

The frame 450 is divided into two communication phases, which are called the arbitration phase 451 and the data phase 452. The frame 450 begins and ends in the arbitration phase 451. The frame 450 begins with an SOF bit and has an arbitration field 453, a control field 454, a data field 455, a checksum field 456 (CRC field), a confirmation field 457 (ACK=acknowledge), and a frame end field EOF (EOF=end of frame). Bits in the arbitration phase 451 of the frame 450 have a longer bit time than bits of the data phase 452, as illustrated in FIG. 2 by way of example.

Bits shown with a thick line on their lower line in FIG. 2 are transmitted in the frame 450 as dominant or ‘0.’ Bits shown with a thick line on their upper line in FIG. 2 are transmitted in the frame 450 as recessive or ‘1.’ Such bits, which are shown in FIG. 2 with a thick line, have a predetermined permanent or fixed value in the frame 450.

The arbitration field 453 comprises an identifier of the frame 450 in the base ID field and in the ID-ext field. The identifier has 29 bits. An SRR bit and an IDE bit are provided between the base-ID field and the ID-ext field. An RRS bit is arranged at the end of the arbitration field 453.

The control field 454 begins with an FDF bit, followed by a res bit. These are followed by a BRS bit and an ESI bit. The control field 454 ends with a DLC field in which the length of the following data field 455 is encoded. The res bit must be transmitted for the frame 450 with a logical value 0, in other words as (logical) 0, i.e. dominant. However, if the subscriber station 20 receives a res bit with a logical value 1, in other words as a (logical) 1, i.e. recessive, the receiving subscriber station 20 will see a protocol exception event PAE and go into the state or into the operating mode of re-integration.

The data field 455 will not be present if the DLC field of the control field 453 has the value 0. The data field 455 has a length corresponding to the value encoded in the DLC field. The value can be up to 64 bytes, as mentioned above.

The checksum field 456 contains in a field SBC the number of stuff bits modulo 8 which have been inserted into the frame 450 according to the bit stuffing rule, namely that following five identical bits, a bit inverse thereto is to be inserted in each case. In addition, the checksum field 456 in a CRC field contains a CRC checksum and, following this, ends with a CRC delimiter CRC-Del.

The confirmation field 457 contains an ACK-Slot bit in which subscriber stations, which currently are only receivers of the frame 450 but not transmitters of the frame, can confirm or not confirm the correct reception of the frame 450 from the bus 40. The confirmation field 457 ends with an ACK-Del bit, which is also called ACK delimiter.

A bit sequence is provided in the frame end field EOF, which bit sequence marks the end of the frame 450. The bit sequence of the frame end field (EOF) thus serves to mark the end of the frame 450. The frame end field (EOF), together with the ACK delimiter, ensures that a number of 8 recessive bits is transmitted at the end of the frame 450. This is a bit sequence that cannot occur within the frame 450. As a result, the end of the frame 450 can be reliably detected by the subscriber stations 10, 20, 30.

After the frame end field (EOF), an interframe space (IFS) (not shown in FIG. 2) follows in the frame 450. In CAN FD this interframe space (IFS) is designed in accordance with ISO11898-1:2015. The interframe space (IFS) has at least 3 bits.

Otherwise, the fields and bits mentioned are from ISO 11898-1:2015 and for this reason are not described in more detail here.

In the case of CAN FD, in the arbitration phase 451, with the aid of an identifier (ID) with bits ID28 to ID18 in the arbitration field 453, negotiation takes place bit by bit between the subscriber stations 10, 20, 30 as to which subscriber station 10, 20, 30 wishes to send the message 45, 46 with the highest priority and will therefore receive exclusive access to the bus 40 of the bus system 1 for the next time for transmission in the subsequent data phase 452. A physical layer such as in CAN and CAN FD is used in the arbitration phase 451. The physical layer corresponds to the bit transmission layer or layer 1 of the conventional OSI model (Open Systems Interconnection Model).

An important point during the phase 451 is that the conventional CSMA/CR method is used, which allows simultaneous access of the subscriber stations 10, 20, 30 to the bus 40 without the higher-priority message 45, 46 being destroyed. As a result, further bus subscriber stations 10, 20, 30 can be added relatively easily to the bus system 1, which is very advantageous.

The CSMA/CR method requires that there must be so-called recessive states on the bus 40, which can be overwritten by other subscriber stations 10, 20, 30 with dominant states on the bus 40. In the recessive state, high-impedance conditions prevail at the individual subscriber station 10, 20, 30, which in combination with the parasites on the bus circuit results in longer time constants. This leads to a limitation of the maximum bit rate of the present-day CAN-FD physical layer at currently about 2 megabits per second in real vehicle use. With the new CAN SIC physical layer, even 5 megabits per second and up to 8 megabits per second are possible.

In the data phase 452, in addition to a portion of the control field 454 of a frame 450, the useful data of the CAN FD frame 450 or of the message 45 are transmitted from the corresponding data field 455 as well as the associated checksum field 456. The switchover from the data phase 452 back to the arbitration phase 451 then takes place.

The subscriber station 10 as the transmitter of the message 45, 46 does not begin transmitting bits of the data phase 452 to the bus 40 until the subscriber station 10 as the transmitter has won the arbitration and the subscriber station 10 as transmitter thus has exclusive access to the bus 40 of the bus system 1 for transmission. The same applies to the subscriber stations 20, 30 when they want to transmit a message 45 or 46 to the bus 40.

FIG. 3 shows, for the message 46, a CAN XL frame 460 as is provided by communication control device 11, namely encoded in a digital transmission signal TxD, for the transmitting/receiving device 12 for transmission to the bus 40. In this case, the communication control device 11 creates the frame 460 in the present exemplary embodiment as compatible with CAN FD, as also illustrated in FIG. 3. The same applies analogously to the communication control devices 31, 51 and the associated transmitting/receiving devices 32, 52 of the subscriber station 30, 50.

According to FIG. 3, the CAN XL frame 460 is divided for CAN communication on the bus 40 into different communication phases 451, 452, namely the arbitration phase 451 and the data phase 452. Following a start bit (SOF), the frame 460 has an arbitration field 463, a control field 464 with an ADS field for a switchover between the communication phases 451, 452, a data field 465, a checksum field 466, and also a frame termination field 467. This is followed by the frame end field EOF, as in the case of a frame 450 according to FIG. 2.

In the arbitration phase 451, arbitration is also executed for the frame 460 with the aid of the identifier (ID), as described above with reference to FIG. 2. In the data phase 452, in addition to a portion of the control field 464 of the frame 460, the useful data of the CAN XL frame 460 or of the message 46 are transmitted from the data field 465 as well as the checksum field 466. In the case of CAN XL according to FIG. 3, the DAS field then follows, which serves for switching from the data phase 452 back to the arbitration phase 451.

As shown in FIG. 3, in the arbitration phase 451 as the first communication phase, the subscriber station 10 uses the format from CAN/CAN FD according to ISO11898-1:2015, as shown in FIG. 2 and described above, partially, in particular up to the FDF bit (inclusive). In contrast, the subscriber station 10 uses, as the second communication phase, a CAN XL format, which is described below, from the FDF bit in the first communication phase as well as in the data phase 452. In the CAN XL data phase 452, symmetrical ‘1’ and ‘0’ levels are used for the transmission on the bus 40, rather than recessive and dominant levels as in CAN FD.

In general, two different stuffing rules are applied in the generation of the frame 460. The dynamic bit stuffing rule of CAN FD applies up to the FDF bit in the arbitration field 453 or for a frame 450 of FIG. 2 so that, after 5 identical bits in succession, a stuff bit inverse thereto is to be inserted. In the data phase 452 up to the FCP field, a fixed stuffing rule applies so that a fixed stuff bit that is inverse to the preceding bit is to be inserted after a fixed number of bits. Alternatively, instead of only one stuff bit, a number of 2 or more bits can be inserted as fixed stuff bits.

In the present exemplary embodiment, the res bit from CAN FD, which is denoted by the XLF bit in the frame 460, is used for switching from the CAN FD format to the CAN XL format. For this reason, the frame formats of CAN FD and CAN XL are identical up to the res bit or XLF bit. Only at this bit can a receiver identify the format in which the frame 460 is transmitted. A CAN XL subscriber station, that is to say in this case the subscriber stations 10, 30, also supports CAN FD. If the bit is transmitted as 1, i.e., recessive, it is the XLF bit and thus identifies the frame 460 as a CAN XL frame. For a CAN FD frame of FIG. 2, the communication control device 11 sets the bit as 0, i.e., as a dominant res bit.

After the XLF bit, a resXL bit follows in the frame 460, which is a dominant bit for future use. The resXL must be transmitted for the frame 460 as 0, i.e. dominant. However, if the subscriber station 10 receives a resXL bit as 1, that is to say recessive, the receiving subscriber station 10 will, for example, see a protocol exception event PAE, and proceed as is done in the case of a CAN FD message 46 for a res=1. If the resXL bit is not needed for synchronization from the recessive XLF bit to the dominant ResXL bit, the resXL bit could be defined exactly the other way around, i.e., that it must be transmitted as 1, i.e., recessive. In this case, in the case of a dominant resXL bit, the receiving subscriber station sees the protocol exception event PAE and changes its operating mode to re-integration.

The resXL bit is followed in the frame 460 by a sequence ADS (arbitration data switch) in which a predetermined bit sequence is encoded. This bit sequence permits a simple and reliable switching from the bit rate of arbitration phase 451 (arbitration bit rate) to the bit rate of the data phase 452 (data bit rate). Optionally, within the ADH bit, the operating mode of the transmitting/receiving device 12, 32 is switched from the operating mode B_451 (SLOW) of the arbitration phase 451 into one of two operating modes B_452_TX, B_452_RX of the data phase 452. The two operating modes of the data phase 452 are an operating mode B_452_TX (FAST_TX) for a transmitting node that is allowed to transmit its signal to the bus 40 in the data phase 452, and an operating mode B_452_RX (FAST_RX) for a receiving node which is only the receiver of the signal from the bus 40.

Subsequent fields up to the beginning of the data field 465 are not described in more detail here. The data field 465 can have up to 2048 bytes.

The data field 465 is followed in the frame 460 by the checksum field 466 with a frame checksum FCRC and an FCP field. Here FCP=frame check pattern. The FCP field consists of 4 bits with in particular the bit sequence 1100. A receiving node uses the FCP field to check whether the receiving node is bit-synchronous with the transmission data stream. In addition, a receiving node synchronizes to the falling edge in the FCP field.

The FCP field is followed by the frame termination field 467. The frame termination field 467 consists of two fields, namely the DAS field, and the confirmation field or ACK field with the at least one ACK bit and the ACK-Dlm bit.

The DAS field contains the DAS sequence (data arbitration switch) in which a predetermined bit sequence is encoded. This DAH, AH1, AL1 bit sequence permits a simple and reliable switchover from the data bit rate of the data phase 452 to the arbitration bit rate of the arbitration phase 451. In addition, during the DAS field, the operating mode of the transmitting/receiving device 12, 32, is optionally switched from one operating mode B_452_TX or B_452_RX (FAST) to the operating mode B_451 (SLOW). Within the DAH bit, the physical layer, i.e. the operating mode of the transmitting/receiving device 12, 32, is switched from FAST_TX or FAST_RX to SLOW. The AH1 bit is followed by the AL1 bit (logical 0) and the AH2 bit (logical 1). The two bits DAH and AH1 ensure that there is enough time for the operating mode switching of the transmitting/receiving device 11, and that all subscriber stations 10, 30 see a recessive level of significantly more than one arbitration bit time before the edge at the beginning of the AL2 bits (logical 0). This ensures a reliable synchronization for the subscriber stations of the bus system.

In the frame termination field 467, the sequence of the DAS field is followed by the confirmation field (ACK). In the confirmation field, bits are provided for confirming or not confirming a correct reception of the frame 460.

In the frame 460, the frame termination field 467 is followed by the frame end field (EOF=end of frame), as in the case of CAN FD according to FIG. 2.

For subscriber stations whose error signaling is not activated and which transmit a CAN XL frame, the frame end field (EOF) has a length which is different depending on whether a dominant bit or a recessive bit has been seen in the ACK bit. If the transmitting subscriber station has received the ACK bit as dominant, the frame end field (EOF) has a number of 7 recessive bits. Otherwise, the frame end field (EOF) is only 5 recessive bits long.

In the frame 450, the frame end field (EOF) is followed by an interframe space (IFS), as previously explained with respect to the frame 450 of FIG. 2.

The following applies to CAN XL.
In contrast to CAN FD, the identifier ID of the frame 460 is called “Priority ID” in the case of CAN XL.
In contrast to CAN FD, CAN XL can transmit the RRS bit as (logical) 0 or as (logical) 1. In CAN FD, the RRS bit is always transmitted as logical 0.
For CAN XL, the bit rate in the data phase 452 must be higher by at least a factor of 2 than the bit rate in the arbitration phase 451.

FIG. 4 shows the basic structure of the subscriber station 10 with the communication control device 11, the transmitting/receiving device 12 and the wake-up module 15, which is part of the transmitting/receiving device 12. The subscriber station 30 is structured in a similar manner, as shown in FIG. 4, but the wake-up module 35 according to FIG. 1 is arranged separately from the communication control device 31 and the transmitting/receiving device 32. For this reason, the subscriber station 30 is not described separately.

According to FIG. 4, the subscriber station 10 has, in addition to the communication control device 11, the transmitting/receiving device 12 and the wake-up module 15, a microcontroller 13 to which the communication control device 11 is assigned, and a system ASIC 16 (ASIC=application-specific integrated circuit), which can alternatively be a system basis chip (SBC) on which a plurality of functions necessary for an electronics module of the subscriber station 10 are combined. In the system ASIC 16, a power supply device 17 which supplies the transmitting/receiving device 12 with electrical energy is installed in addition to the transmitting/receiving device 12. The power supply device 17 usually supplies a voltage CAN_supply of 5 V. Depending on requirements, however, the power supply device 17 can provide a different voltage with a different value. Additionally or alternatively, the power supply device 17 can be designed as a current source.

The communication control device 11 can optionally have an encoding module 18, which is structured like the encoding module 58 of the subscriber station 50.

The transmitting/receiving device 12 also has a transmitting module 121 and a receiving module 122. Although reference is always made to the transmitting/receiving device 12 below, it is alternatively possible to provide the receiving module 122 in a separate device externally from the transmitting module 121. The transmitting module 121 and the receiving module 122 can be constructed as in a conventional transmitting/receiving device 22. The transmitting module 121 can in particular have at least one operational amplifier and/or a transistor. The receiving module 122 can in particular have at least one operational amplifier and/or a transistor.

The transmitting/receiving device 12 is connected to the bus 40, more specifically its first bus wire 41 for CAN_H and its second bus wire 42 for CAN_L. The voltage supply for the power supply device 17 for supplying the first and second bus wires 41, 42 with electrical energy, in particular with the voltage CAN-Supply, is effected via at least one terminal 43. The connection to ground or CAN_GND is realized via a terminal 44. The first and second bus wires 41, 42 are terminated with a terminating resistor 409.

In the transmitting/receiving device 12, the first and second bus wires 41, 42 are connected not only to the transmitting module 121, which is also referred to as a transmitter, but also to the receiving module 122, which is also referred to as a receiver, although the connections are not shown in FIG. 4 for the sake of simplicity.

During operation of the bus system 1, the transmitting module 121 can convert a transmission signal TXD of the communication control device 11, which is transmitted via terminals TXD, into corresponding signals CAN_H, CAN_L for CAN or CAN FD and into signals CAN_XL_H, CAN_XL_L in the case of CAN XL for the bus wires 41, 42 and transmits these signals to the bus 40 at the terminals for CAN_H and CAN_L. The digital transmission signal TxD is based on a CAN FD frame 450 of FIG. 2 or a CAN XL frame 460 of FIG. 3, as mentioned above.

From signals CAN_H and CAN_L received from the bus 40, which are shown in FIG. 5, the receiving module 122 forms a digital reception signal RxD and forwards it to the communication control device 11, as shown in FIG. 4.

According to the example of FIG. 5, the signals CAN-XL_H and CAN-XL_L have, at least in the arbitration phase 451, the dominant and recessive bus levels 401, 402, as from CAN. A difference signal VDIFF=CAN-XL_H−CAN-XL_L, which is shown in FIG. 6 for the arbitration phase 451, is formed on the bus 40. For recognizing the individual bits of the signal VDIFF with the bit time t_bt1, the receiving module 122 uses a reception threshold T_a of, for example, 0.7 V in the arbitration phase 451. In the data phase 452, the bits of the signals CAN_H and CAN_L can be transmitted faster, i.e., with a shorter bit time t_bt2, than in the arbitration phase 451. In CAN FD und CAN XL, the signals CAN-XL_H and CAN-XL_L thus differ in the data phase 452 from the conventional signals CAN_H and CAN_L, at least in terms of their faster bit rate. Depending on requirements, the receiving module 122 uses at least one other reception threshold in the data phase 452 than in the arbitration phase 451.

The sequence of states 401, 402 for the signals CAN-XL_H, CAN-XL_L in FIG. 5 and the resulting profile of the voltage VDIFF of FIG. 6 serves only to illustrate the function of the subscriber station 10. The sequence of the data states for the bus states 401, 402 can be selected as required.

In other words, the transmitting module 121, when it is switched into a first mode of operation B_451 (SLOW), according to FIG. 5 generates a first data state as bus state 402 with different bus levels for two bus wires 41, 42 of the bus line and a second data state as bus state 401 with the same bus level for the two bus wires 41, 42 of the bus line of the bus 40.

In addition, in a second operating mode B_452_TX (FAST_TX), which the data phase 452 comprises, the transmitting module 121 transmits the bits at a higher bit rate to the bus 40 for the time profiles of the signals CAN_H, CAN_L in CAN FD and CAN XL. In the data phase 452 of CAN XL, the CAN_H and CAN_L signals can also be generated with a physical layer different from that in CAN FD. As a result, the bit rate in the data phase 452 can be increased even further than in the case of CAN FD. At least in the case of CAN XL, a subscriber station (receiving node) will set a third operating mode B_452_RX (FAST_RX) in its transmitting/receiving device if this subscriber station is not a transmitter of the frame 450 in the data phase 452, i.e. is not a transmitting node.

In one operating mode B_LB (idle), the communication control device 11 is switched to the idle or standby state. That is to say, the communication control device is waiting for the reception of a message 45, 46. In this state, no communication takes place on the bus 40. In other words, no signal is received at the RxD terminal of the communication control device 11 of FIG. 4 or the value logical 1 is present, since the recessive level on the bus 40 corresponds to a bit value=1 or to a logical 1 in the reception signal RxD.

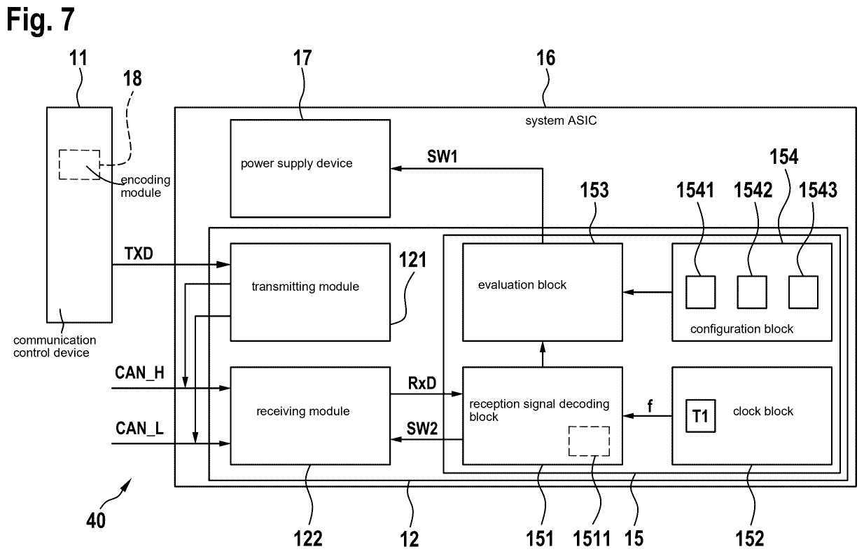

The functionality of the wake-up module 15, which differs from current communication standards for Classical CAN, for CAN FD and for CAN XL, is also described below with reference to FIG. 7.

FIG. 7 shows the basic structure of the wake-up module 15 for the transmitting/receiving device 12 of the subscriber station 10. In FIG. 7, only the signals and blocks relevant to the wake-up module 15 are shown, as follows. The wake-up module 15 has a reception signal decoding block 151, a clock block 152, an evaluation block 153, and a configuration block 154.

The reception signal decoding block 151 optionally has a timing element 1511, which is in particular a counter and/or a clock.

If the subscriber station 10 is to be used optionally as a transmitter of a frame 48, the subscriber station 10 has the encoding module 18 already mentioned above and shown in FIG. 4. The encoding module 18 can be constructed like the encoding module 58 of the subscriber station 50.

The clock block 152 outputs a clock T1 with the frequency f to the reception signal decoding block 151. The reception signal decoding block 151 outputs a signal SW2 to the receiving module 122 if the receiving module 122 is to switch its operating mode from the operating mode B_451 (SLOW) of the arbitration phase 451 to the operating mode B_452_RX of the data phase 452. In the operating mode B_452_RX, the receiving module 122 is set to receive the bits with the bit duration t_bt2 (FIG. 5) of the data phase 452. The evaluation block 153 can output a signal SW1 to the power supply device 17.

During operation of the bus system 1, the subscriber station 10 can be put into a sleep mode by a frame 49, as mentioned above. In other words, the subscriber station 10 is put to sleep with a frame 49. The evaluation as to whether a put-to-sleep frame 49 has been received can take place by means of software, which is implemented in particular in the evaluation block 153 or a block not shown.

In sleep mode, the transmitting module 121 of the transmitting/receiving device 12 is deactivated. In sleep mode, the transmitting/receiving device 12 does not drive the signals CAN_H and CAN_L to the bus 40.

In order to recognize when the sleep mode is to be exited again, the wake-up module 15 proceeds as follows.

The receiving module 122 decodes the digital reception signal RxD from the signals CAN_H and CAN_L by means of a reception threshold, as already described above. The receiving module 122 outputs the digital reception signal RxD to the reception signal decoding block 151.

The reception signal decoding block 151 decodes the digital bit stream in the reception signal RxD and outputs the result to the evaluation block 153. For decoding the bit stream, the reception signal decoding block 151 uses the clock T1 received from the clock block 152.

The evaluation block 153 is designed to filter and compare the result received from the block 151. The evaluation block 153 evaluates whether the CAN frame 45, 46, 47, 48, 49 received from the bus 40 corresponds to the previously defined format for the wake-up frame 48. For this purpose, the evaluation block 153 uses at least one of the wake-up conditions 1541, 1542, 1543 stored in the configuration block 154. For example, the wake-up conditions 1541, 1542, 1543 may include at least one of the following conditions/parameters, namely, the identifier ID (priority ID) of the wake-up frame 48, a value for the RRS bit, a combination of the identifier ID (priority ID) of the wake-up frame 48 and the value for the RRS bit. Of course, other or additional conditions/parameters 1541, 1542, 1543 can be used.

For the evaluation by the block 153, the block 151 decodes a CAN XL frame 460 in an incoming reception signal RxD up to the bit resXL (FIG. 3). Alternatively, the block 151 decodes a CAN XL frame 460 in the incoming reception signal RxD only up to the bit RRS.

In addition, the evaluation block 153 evaluates incoming CAN XL frames 460 or the corresponding reception signal RxD up to the bit resXL (FIG. 3), which is described above with reference to FIG. 3. Alternatively, the evaluation block 153 performs an evaluation up to the bit RRS (FIG. 3).

The decoding block 151 and/or the evaluation block 153 recognize(s) up to the bit resXL, i.e., before the beginning of the data phase 452 and thus before the beginning of the data field 465, whether or not the frame is in principle a wake-up frame 48. Recognition takes place on the basis of one of the following conditions, namely,
a) the value of the bit RRS, which is logical 0 or logical 1
b) the value of the priority ID.

According to a first modification of the evaluation block 153, for recognizing whether or not the frame is a wake-up frame 48, the evaluation block 153 is designed to evaluate the combination of the aforementioned conditions a) and b).

For recognizing whether the CAN frame 45, 46, 47, 48, 49 received from the bus 40 corresponds to the previously defined format for the wake-up frame 48 intended for the subscriber station 10, the evaluation module 15 proceeds further as follows.

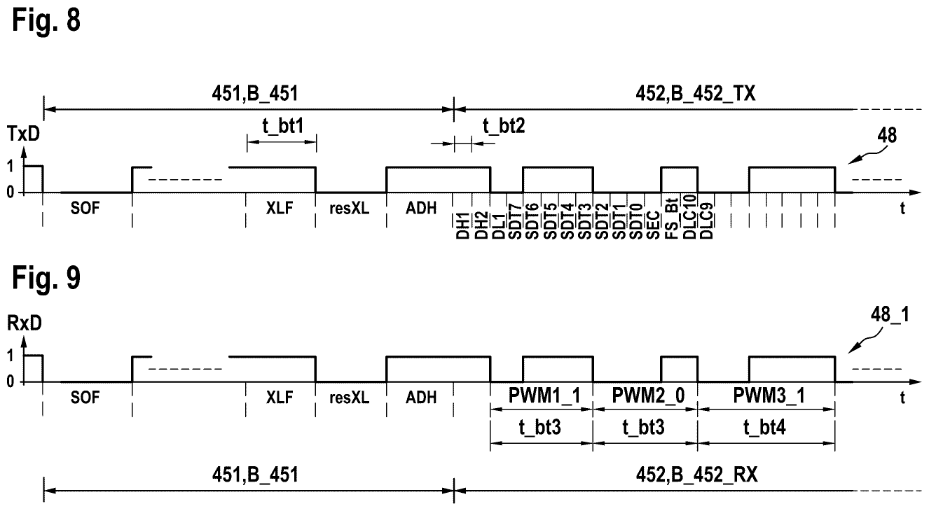

FIG. 8 illustrates that the transmitter, for example the subscriber station 50, in particular its encoding module 58, encodes a digital transmission signal TxD for a frame 48, which is based on the CAN XL frame 460 according to FIG. 3. The serially transmitted transmission signal TxD has the logical values 0 and 1. In FIG. 8, only the portions at the beginning of the frame 48 at the start bit SOF and at the transition between the arbitration phase 451 and the data phase 452 of the transmission signal TxD are shown in more detail. In the data phase 452, a fixed stuff bit FS_Bt is inserted between the bits SEC, DLC10. The transmitter switches after the bit ADH in order to generate the bits with the bit duration t_bt2 of the data phase 452. In addition, after the bit ADH, the transmitter can switch the operating mode of its transmitting/receiving device, in particular its transmitting module, from the operating mode B_451 (SLOW) of the arbitration phase 451 to the operating mode B_452_TX of the data phase 452 in order to drive the bits with the bit duration t_bt2 in the data phase 452 accordingly to the bus 40.

According to FIG. 9, the receiver receiving the signal based on the transmission signal TxD of FIG. 8 and transmitted via the bus 40 interprets or decodes the content of the reception signal RxD after the resXL bit, and thus in the data phase 452, differently than is usual for a CAN XL frame 460. Consequently, the receiver generates a signal RxD, as shown in FIG. 9 as an example. For example, the receiver is the subscriber station 10.

In the example of FIG. 9, the receiver is designed to perform an interpretation or decoding of PWM symbols from the bit ADH. PWM stands for pulse width modulation. FIG. 9 shows the three PWM symbols PWM1_1, PWM2_0, PWM3_1. That is to say, the first and third PWM symbols shown, PWM1_1, PWM3_1, have the logical value 1. The second PWM symbol shown, PWM2_0, has the logical value 0. The length of the PWM symbols PWM1_1, PWM2_0 corresponds to a bit duration t_bt3. The length of the PWM symbol PWM3_1 corresponds to a bit duration t_bt4. Each of the bit durations t_bt3, t_bt4 is a multiple of the bit duration t_bt2 of a data bit.

For generating the transmission signal TxD of FIG. 8, the transmitter proceeds as follows. For example, the transmitter is the subscriber station 50.

For this purpose, the transmitter of the frame 48 encodes longer PWM symbols in the transmission signal TxD with a plurality of short bits of the data phase 452. The transmitter can choose how many data bits (bit duration t_bt2) should be used per PWM symbol. That is to say, the number of data bits used per PWM symbol is selectable. However, it is more advantageous if the PWM symbols consist of fewer data bits in order to make the length of the wake-up frame 48 (WUF) to be transmitted as short as possible. Independently, within the wake-up frame 48, the length of the PWM symbols may vary, as shown in FIG. 9 with the symbol lengths t_bt3, t_bt4. As a result, the PWM symbols can be dimensioned in such a way that the fixed stuff bits FS_Bt in the data phase 452 do not interfere with the decoding of the PWM symbols.

The transmitter basically takes into account that a PWM symbol begins and ends with a predetermined edge. The predetermined edge can be either a falling edge or a rising edge. In addition, it is true, for example, that, if a PWM symbol has a longer 0-phase that is more than 50% longer than a 1-phase, the PWM symbol corresponds to a bit with the logical value 0 and, for example, one of the symbol lengths/bit durations t_bt3, t_bt4. Conversely, it is true that, if a PWM symbol has a longer 1-phase that is more than 50% longer than a 0-phase, the PWM symbol corresponds to a bit with the logical value 1 and, for example, one of the symbol lengths/bit durations t_bt3, t_bt4.

For example, if the transmitter uses four data bits to encode a PWM symbol, with the two falling edges delimiting a PWM symbol, then a PWM symbol begins with a 0-phase and ends with a 1-phase so that a bit with the value ‘0’ corresponds to the PWM symbol “0001” and a bit with the value ‘1’ corresponds to the PWM symbol “0111”. The transmitter knows at which locations in the frame 450 a fixed stuff bit is inserted, and is designed to take this into account in the PWM encoding. As previously explained, a fixed stuff bit is always inverse to the preceding bit.

As a result, the four data bits in the transmission signal TxD, which the transmitter encodes into a PWM symbol, can have a total of five bits due to a stuff bit. If, as a result, the length ratio between the 0-phase and the 1-phase is not shifted beyond the 50% limit and no additional edge is inserted, a receiver can correctly decode the PWM symbol generated by the transmitter.

In the event that additional edges would be generated by the stuff bits in the four data bits that the transmitter encodes into a PWM symbol, the transmitter proceeds as follows. That is to say, the transmitter is designed to insert additional filler bits, provided that the length ratio between the 0-phase and the 1-phase is not shifted beyond the 50% limit. The filler bits shift the stuff bit edge such that the stuff bit edge coincides with the PWM symbol edge.

For example, the transmitter encodes the PWM symbol, which comes from the bit sequence “0111” in the transmission signal TxD and would become the bit sequence “01o11” if a fixed stuff bit o (logical value 0) were inserted, with an added filler bit at the beginning as the bit sequence “10111”, which then becomes the bit sequence “10I111” with a fixed stuff bit I (logical value 1).

That is to say,
instead of “01o11”, the transmitter encodes the bit sequence “0111” via “10111” into “10I111”, and
instead of “0110o1”, the transmitter encodes the bit sequence “0111” via “10011” into “100I11”, and
instead of “0I001”, the transmitter encodes the bit sequence “0001” via “10001” into “1o0001”.

In the three cases mentioned, the preceding symbol is extended by a ‘1’ because the falling edges are the symbol boundaries. This turns the bit sequence “0001” into the bit sequence “00011” and the bit sequence “0111” into the bit sequence “01111” but can be decoded correctly by the receiver.

If the preceding symbol was “0111”, the following applies:

Instead of “00I01”, the transmitter encodes the bit sequence “0001” via “11001” into “11o001”.

The preceding symbol is extended by two ‘1’s, turning “0111” into “011111”, which can be correctly decoded by the receiver.

However, if the preceding symbol was “0001”, the transmitter is designed to re-encode both PWM symbols, i.e., also the preceding symbol “0001”. That is to say:

Instead of “0001” “00I01”, the two symbols are re-encoded as “00001” “1o0001”.

In this way, the PWM symbol is (re-)encoded such that the stuff bit becomes part of a 0-phase or 1-phase, and such that the edge caused by the stuff bit coincides with the falling edge at the PWM boundaries or with the one rising edge within the PWM symbol. On the one hand, the filler bit can shift the (relative) position of the stuff bit and, if it is located directly before the stuff bit, it can invert the stuff bit.

This prevents a stuff bit that is inserted into the symbol from generating one or even two additional edges in the symbol and thus causing incorrect decoding at the receiver.

As an alternative to using falling edges as the limit of the PWM symbol, rising edges can be used as the limit of the PWM symbol.

Of course, other encodings for the PWM symbols are possible, especially if the transmitter is designed to generate or encode the symbols from more than 4 data bits. For example, if the PWM symbols are based on 5 data bits, two PWM symbols fit between two stuff bits; in this case, a stuff bit is at the end of every second PWM symbol. In this case, no re-encoding with filler bits is necessary.

In contrast, the receiver proceeds to generate and evaluate the reception signal RxD of FIG. 9 as follows. For example, the receiver is the subscriber station 10.

The reception signal decoding block 151 outputs the signal SW2 to the receiving module 122 at the beginning of the ADH bit in order to switch the receiving module 122 (FIG. 7) to the operating mode FAST_RX. The block 151 is thus able to correctly receive the following bus levels, which form or have been formed on the bus 40 due to the transmission signal TxD of FIG. 8.

In addition, the reception signal decoding block 151 does not decode the following bits in the data phase 452 of the CAN XL wake-up frame 48 according to the CAN XL protocol previously described with reference to FIG. 3. Instead, the reception signal decoding block 151 uses an alternative decoding, for example the PWM symbols shown in FIG. 9. That is to say, in this example, the block 151 is designed to interpret and decode PWM symbols. Of course, another alternative decoding can be used.

The receiver of the frame 48, more precisely its block 151, decodes the PWM symbols PWM1_1, PWM2_0, PWM3_1 in FIG. 9 back to bits with the logical values 0 or 1 for a frame 48_1. The decoding block 151 outputs the decoded data or the frame 48_1 to the evaluation block 153. As a result, the evaluation block 153 can evaluate whether or not the received frame 48_1 is to wake up the subscriber station 10.

The transmitting/receiving device 12, in particular its wake-up module 15, thus performs a two-stage method in which, first, or at the beginning of the signal/frame, it is checked whether the signal received from the bus 40 is based in principle on a wake-up frame 48, and, in a second stage in the data phase 452 of the wake-up frame 48, it is checked whether the wake-up frame 48 is intended for the associated subscriber station 10. In the second stage, however, no decoding corresponding to the encoding with which the wake-up frame 48 was encoded is used, but a different decoding method is used.

In addition, the transmitter of the frame 48 sets the values of the short bits (high data rate) in the data phase 452 in such a way that a lower bit rate is emulated thereby. As a possibility for an alternative bit decoding (lower bit rate) in the data phase 452, the receiver can thus decode each PWM symbol consisting of a plurality of data bits, as a bit with a longer bit duration than the bit duration t_bt2 of a data bit, namely with, for example, the symbol length or bit duration t_bt3 or the symbol length or bit duration t_bt4. This results in a lower bit rate in the data phase 452 at the receiver.

If the evaluation of the evaluation block 153 shows that the CAN frame 45, 46, 47, 48, 49 received from the bus 40 corresponds to the previously defined format for the wake-up frame 48, the evaluation block 153 outputs a corresponding signal SW1 to the power supply device 17. The signal SW1 can, for example, be a switching signal designed to switch on the power supply device 17.

The transmitter and the receiver can also be designed to transmit or recognize a put-to-sleep frame 49 by means of the method described above.

If the evaluation of the evaluation block 153 shows that the CAN frame 45, 46, 47, 48, 49 received from the bus 40 corresponds to the previously defined format for the put-to-sleep frame 49, the evaluation block 153 outputs a corresponding signal SW1 to the power supply device 17. The signal SW1 can, for example, be a switching signal designed to switch off the power supply device 17.

A great advantage of the selective wake-up method described above is that the beginning and end of a PWM symbol can be easily recognized by the rising (or falling) edge. To this end, a clock with a high tolerance is sufficient.

Another great advantage of the selective wake-up method described above is that the length of a PWM symbol has no influence on the decoding of the frame 48_1. The wake-up frame 48_1 (WUF) is thus independent of the bit rate of the data phase 452 or the length t_bt2 of the data bits. The transmitter can thus transmit the same frame 48 (WUF) independently of the bit rate of the data phase 452 or the length t_bt2 of the data bits. The resulting temporal PWM symbol length should remain the same within a tolerance. A possible tolerance here is, for example, 500 ns to 5000 ns.

Another great advantage of the selective wake-up method described above is that the transmitter can “hide” the fixed stuff bits FS_Bt in the data phase 452 of the CAN XL frame 48 very well in the PWM symbols so that the fixed stuff bits FS_Bt do not interfere with the decoding by the receiver.

If CAN FD communication takes place on the bus 40 instead of CAN XL communication, the wake-up module 25 of the subscriber station 20 can also be put to sleep or woken up, as described in the ISO standard 11898-2:2016. For this purpose, the wake-up module 25 is partially identical in structure to the wake-up module 15. However, the configuration of the configuration block 154 is different than previously described with respect to the wake-up module 15. The wake-up module 25 may additionally or alternatively have a design and configuration as described below.

In the subscriber station 20, the wake-up module 25 proceeds as follows in order to check whether the subscriber station 20 should be put to sleep or woken up, as specified in the ISO standard 11898-2:2016. Accordingly, the wake-up module 25 may be configured to check the following for a wake-up:
whether the CAN identifier, which may also be referred to as a frame identifier, of the received frame 45, 46, 48, 49 corresponds to the CAN identifier defined for the wake-up frame 48.
whether the data length of the received frame 45, 46, 48, 49 in the DLC code corresponds to the data length defined for the wake-up frame 48.
whether the data mask of the received frame 45, 46, 48, 49 corresponds to the data mask or the ‘1’ bits in the data field 465 of the wake-up frame 48 in the case of which the subscriber station 20 is to wake up.

If the wake-up module 25 determines that all of the above conditions are met for the received frame 45, 46, 48, 49, i.e., a frame 48 has been received, the wake-up module 25 carries out the wake-up. As a result, the transmitting module 121 is reactivated. The method is described in more detail in the standard ISO 11898-2:2016.

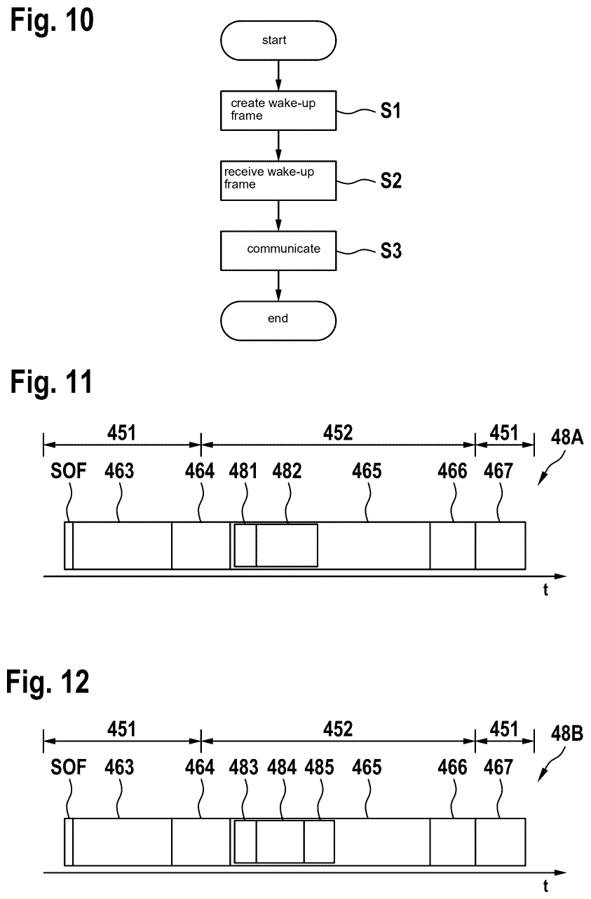

FIG. 10 illustrates a method which is carried out in the bus system 1 and in which the transmitting/receiving devices 10, 30, 50, in particular their wake-up modules 15, 35, 55, are designed for selective wake-up, as described above. In addition, it is assumed below that the subscriber station 20 is also designed to transmit and receive CAN XL frames. Alternatively, at least one additional other subscriber station 10 and/or at least one additional CAN FD subscriber station 20 may also be present. The subscriber station 50 is the management subscriber station.

The following sequence may result.

In a first step, all subscriber stations 10, 20, 30, 50 on the bus 40 are awake and communicate.

In a second step, which takes place any time later, the subscriber station 50 uses a CAN XL frame, namely, a put-to-sleep frame 49, to put the subscriber stations 20, 30 to sleep.

In a third step, even if the subscriber stations 20, 30 are sleeping, the subscriber stations 10, 50 can continue to communicate without the subscriber stations 20, 30 waking up.

In a fourth step, which takes place any time later, the function of the subscriber station 30 is required again so that the subscriber station 30 is to be woken up.

As a result, the subscriber station 50, in particular its wake-up module 55, carries out a method as shown in FIG. 10.

According to FIG. 10, after its start, the method first goes to a step S1. In step S1, the subscriber station 50 creates a wake-up frame 48 for the subscriber station 30 and transmits it via the bus 40. In this example, the wake-up frame 48 is a CAN XL frame, in which the bit RRS=1 and/or the priority ID has the value expected by the wake-up module 35 according to the configuration in the associated configuration block for a wake-up frame 48. In addition, an encoding is present in the data phase 452, as described above with reference to FIG. 8. The method then proceeds to a step S2.

In step S2, the subscriber station 30 receives the wake-up frame 48, as described above with reference to FIG. 7 to FIG. 9. As a result, the subscriber station 30 wakes up since its evaluation module 25, 30 recognizes the wake-up frame 48 by the value of the bit RRS and/or by the value of the priority ID and the encoding in the data phase 452. The method then proceeds to a step S3.

In step S3, the subscriber stations 10, 30, 50 are awake and can communicate. The method is then terminated.

Alternatively, the method can return to step S1. According to another alternative, the method proceeds to another step, in which the subscriber station 50 transmits a wake-up frame 48 for waking up other subscriber stations of the bus system 1 or a put-to-sleep frame 49 for putting other subscriber stations of the bus system 1 to sleep.

FIG. 11 illustrates the structure of a wake-up frame 48A according to a second exemplary embodiment over time t, in which the transmitting/receiving devices 10, 30, 50, in particular their wake-up modules 15, 35, 55 and at least one of the encoding modules 18, 58 are designed for selective wake-up.

The frame 48A is structured largely according to a CAN XL frame 460, as described above with reference to FIG. 3 and the first exemplary embodiment.

However, in the present exemplary embodiment, the transmitter, for example the subscriber station 50, in particular its encoding module 58, is designed to insert a preamble 481 and a pulse-width-modulated region 482 into the frame 48A. The preamble 481 marks the beginning of the pulse-width-modulated region of the CAN XL frame 48A. In the example shown in FIG. 11, the preamble 481 and the pulse-width-modulated region 482 are inserted in the data field 465. In particular, the preamble 481 and the pulse-width-modulated region 482 are inserted at the beginning of the data field 465. However, the preamble 481 and the subsequent pulse-width-modulated region 482 may be arranged at a different location in the data field 465.

The preamble 481 may comprise a plurality of, but at least two, PWM symbols structured accordingly, as described above with reference to FIG. 8 and FIG. 9 for the first exemplary embodiment. A preamble 481 consisting of 8 PWM symbols could, for example, be 11110000 or 00001111. Of course, the value for the preamble 481 can be selected to be different from the values mentioned. In particular, the preamble 481 itself does not have to be pulse-width-modulated, i.e., it does not have to comprise any PWM symbols.

The value and/or the arrangement of the preamble 481 in the frame 48A is chosen in such a way that the preamble 481 clearly marks the beginning of the data field 465 and cannot occur accidentally beforehand.

Accordingly, the reception signal decoding block 151 is designed to ignore everything after the resXL bit (FIG. 3) until the block 151 has recognized the, in particular PWM-encoded, preamble 481 of FIG. 11. The reception signal decoding block 151 then forwards the decoded PWM symbols to the evaluation block 153 so that the block 153 can evaluate whether or not the frame 48A should wake up the subscriber station 10.

The preamble 481 has the advantage that predetermined fields in the CAN XL frame 460, on which the frame 48A is based, are omitted or skipped by the decoding block 151 during decoding. Such predetermined fields are, on the one hand, fields that the transmitter cannot simply determine, such as the SBC field, the checksum field PCRC, etc., which are shown in FIG. 3. On the other hand, such predetermined fields are also fields in the CAN XL frame 460 of FIG. 3 that the transmitter can only determine freely to a limited extent, such as the DLC field, the VCID field, the SDT field, the AF field.

In a third exemplary embodiment of the bus system 1, the transmitting/receiving device 12 is designed as follows. Instead of the preamble 481 of FIG. 11, the transmitting/receiving device 12, in particular the reception signal decoding block 151, is designed to start a timing element, for example the timing element 1511 of FIG. 7, from the resXL bit. Subsequently, the reception signal decoding block 151 decodes the data stream of the reception signal RxD by means of PWM symbols only after the timing element 1511 has expired.

FIG. 12 illustrates the structure of a wake-up frame 48B according to a fourth exemplary embodiment over time t, in which the transmitting/receiving devices 10, 30, 50, in particular their wake-up modules 15, 35, 55, and the optional encoding module 18 are designed for selective wake-up.

The frame 48B is structured largely according to a CAN XL frame 460, as described above with reference to FIG. 3 and the first exemplary embodiment. However, a separate frame format is present in the data field 465 of the frame 48B for the alternatively encoded bit stream.

In the example of FIG. 12, the frame format in the data field 465 of the frame 48B is structured as follows.

The first X bits, for example 4 bits or the like, encode a DLC 483 (data length code) so that the data length can be M bytes, i.e., 0 to 15 bytes in the example of X=4. M and X are natural numbers including 0. This is followed by a data field 484 in which the 0 to 15 bytes are arranged according to the value in the DLC 483. This is followed by a check field 485.

For example, the check field 485 can contain a checksum CRC. Alternatively, the check field 485 contains one or more parity bit(s). The check field 485 is used to check whether the received RXD data stream is consistent. This check can be performed by the reception signal decoding block 151 or the evaluation block 153.

According to a modification of the fourth exemplary embodiment, the frame 48B comprises only the fields 483, 484, 485.

The recognition of the wake-up frame 48 with the method described above has the advantage that selective wake-up of individual subscriber stations 10, 20, 30 is possible. The thus possible selective wake-up avoids unnecessary waking and putting back to sleep and the data traffic caused thereby on the bus 40.

As a result, both the energy consumption of the bus system 1 can be minimized and the transmittable net data rate on the bus 40 can be increased.

All previously described embodiments of the subscriber stations 10, 20, 30, of the bus system 1 and the method executed therein can be used individually or in all possible combinations. In particular, all features of the previously described exemplary embodiments and/or their modifications can be combined as desired. Additionally or alternatively, the following modifications are possible in particular.

Even if the present invention is previously described using the example of the CAN bus system, the present invention can be used in any communication network and/or communication method in which two different communication phases are used in which the bus states generated for the different communication phases are different.

In particular, the bus system 1 according to the exemplary embodiments can be a communication network in which data can be transmitted in series at two different bit rates. It is advantageous, but not necessarily a prerequisite, for an exclusive, collision-free access of a subscriber station 10, 20, 30 to a common channel to be ensured for the bus system 1, at least for certain time periods.

In the exemplary embodiments, the number and arrangement of the subscriber stations 10, 20, 30, 50 in the bus system 1 is arbitrary. In particular, the subscriber station 20 in the bus system 1 can be omitted. It is possible for one or more of the subscriber stations 10 or 30 to be present in the bus system 1. It is possible for all subscriber stations in the bus system 1 to be designed identically, i.e., only subscriber stations 10 or only subscriber stations 30 are present.

What is claimed is:

1. A transmitting/receiving device for selectively waking up a subscriber station of a serial bus system, comprising:
a transmitting module configured to transmit a transmission signal as an analog signal, which is created for communication in the bus system based on a frame, as an analog signal to the bus of the bus system;
a receiving module configured to receive an analog signal from the bus of the bus system and to generate a digital reception signal from an analog signal received from the bus; and
a wake-up module configured to wake up the subscriber station after the subscriber station has been put to sleep to save energy;
wherein the wake-up module is configured to serially carry out at least two different evaluations to decide whether or not the digital reception signal corresponds to a wake-up frame which gives instructions to activate the transmitting module to wake up the subscriber station; and
wherein, for the decision as to whether or not the digital reception signal corresponds to the wake-up frame, the wake-up module is designed to decode the digital reception signal in a predetermined region according to a different format than the predetermined region was encoded in the transmission signal.

2. The transmitting/receiving device according to claim 1, wherein, for decoding in the different format, the wake-up module is configured to decode the digital reception signal in at least a portion of the predetermined region by using at least a first bit duration which is a multiple of a second bit duration with which the predetermined region was encoded in the transmission signal.

3. The transmitting/receiving device according to claim 1, wherein, for decoding in the different format, the wake-up module is configured to carry out pulse width modulation decoding in at least a portion of the predetermined region.

4. The transmitting/receiving device according to claim 1, wherein the predetermined region includes a preamble and a pulse-width-modulated region, and wherein the preamble is configured to mark a beginning of the pulse-width-modulated region.

5. The transmitting/receiving device according to claim 1, wherein the predetermined region includes a field for a data length code, a data field corresponding to the data length code, and a check field for checking correctness of at least a portion of the predetermined region, and wherein, for evaluating the content of the fields of the predetermined region, the wake-up module is configured to carry out decoding in the predetermined region.

6. The transmitting/receiving device according to claim 1, wherein the frame is divided into a first communication phase and a subsequent second communication phase so that, in the first communication phase, subscriber stations of the bus system can negotiate which of the subscriber stations of the bus system will be given at least temporarily exclusive, collision-free access to the bus in a subsequent second communication phase, and wherein the predetermined region is arranged in the second communication phase of the frame, in a data field of the frame.

7. The transmitting/receiving device according to claim 1, wherein the wake-up module is configured to, before decoding the predetermined region, to check at least one of the wake-up conditions to decide whether or not the digital reception signal corresponds to the wake-up frame, and wherein the wake-up module is configured to switch the receiving module from a first operating mode to a second operating mode, which differs from the first operating mode, wherein the at least one wake-up condition is present.

8. The transmitting/receiving device according to claim 7, wherein the at least one wake-up condition is a priority ID which determines with which temporal priority the frame could be transmitted to the bus.

9. The transmitting/receiving device according to claim 7, wherein the at least one wake-up condition is a single bit which is arranged directly after the priority ID in the received frame.

10. The transmitting/receiving device according to claim 9, wherein the received frame is a CAN XL frame and the single bit is an RRS bit.

11. The transmitting/receiving device according to claim 1, wherein the wake-up module includes:
a decoding block configured to decode the digital reception signal output by the receiving module based on a frame which was used to create the analog signal received from the bus of the bus system, and
an evaluation block configured to evaluate a result output by the decoding block as to whether or not the digital reception signal corresponds to the wake-up frame.

12. The transmitting/receiving device according to claim 7, further comprising:
a configuration block configured to store at least one of the at least two wake-up conditions;
wherein the evaluation block is configured to carry out its evaluation by accessing the configuration block; and
wherein the evaluation block is configured to generate a signal for activating a power supply for the transmitting module when the digital reception signal corresponds to the wake-up frame.

13. A subscriber station, comprising:
a transmitting/receiving device
a transmitting module configured to transmit a transmission signal as an analog signal, which is created for communication in the bus system based on a frame, as an analog signal to the bus of the bus system,
a receiving module configured to receive an analog signal from the bus of the bus system and to generate a digital reception signal from an analog signal received from the bus, and
a wake-up module configured to wake up the subscriber station after the subscriber station has been put to sleep to save energy,
wherein the wake-up module is configured to serially carry out at least two different evaluations to decide whether or not the digital reception signal corresponds to a wake-up frame which gives instructions to activate the transmitting module to wake up the subscriber station, and
wherein, for the decision as to whether or not the digital reception signal corresponds to the wake-up frame, the wake-up module is designed to decode the digital reception signal in a predetermined region according to a different format than the predetermined region was encoded in the transmission signal; and
a communication control device which is configured to sample and evaluate the digital reception signal generated by the transmitting/receiving device according to a predetermined frame, wherein the communication control device is configured to control communication of the subscriber station with at least one other subscriber station of the bus system and to evaluate the digital reception signal, for which a bit time in a first communication phase can differ from a bit time in a second communication phase.

14. The subscriber station according to claim 13, wherein the communication control device is configured, in the first communication phase, to negotiate with the other subscriber stations as to which subscriber station of the bus system will be given at least temporarily exclusive, collision-free access to the bus in a subsequent second communication phase.

15. The subscriber station according to claim 13, wherein the subscriber station is configured to transmit a wake-up frame to the bus of the bus system to selectively wake up at least one other subscriber station of the bus system after it has been put to sleep.

16. A bus system, comprising:
a bus; and
a first subscriber station and at least one second subscriber station, each subscriber station of the first and second subscriber stations including:
a transmitting/receiving device including:
a transmitting module configured to transmit a transmission signal as an analog signal, which is created for communication in the bus system based on a frame, as an analog signal to the bus of the bus system,
a receiving module configured to receive an analog signal from the bus of the bus system and to generate a digital reception signal from an analog signal received from the bus, and
a wake-up module configured to wake up the subscriber station after the subscriber station has been put to sleep to save energy,
wherein the wake-up module is configured to serially carry out at least two different evaluations to decide whether or not the digital reception signal corresponds to a wake-up frame which gives instructions to activate the transmitting module to wake up the subscriber station, and
wherein, for the decision as to whether or not the digital reception signal corresponds to the wake-up frame, the wake-up module is designed to decode the digital reception signal in a predetermined region according to a different format than the predetermined region was encoded in the transmission signal; and
a communication control device which is configured to sample and evaluate the digital reception signal generated by the transmitting/receiving device according to a predetermined frame, wherein the communication control device is configured to control communication of the subscriber station with at least one other subscriber station of the bus system and to evaluate the digital reception signal, for which a bit time in a first communication phase can differ from a bit time in a second communication phase;
wherein the second communication subscriber is connected to the first subscriber station via the bus in such a way that the first and second subscriber stations can communicate serially with one another.

17. A method for selectively waking up a subscriber station in a serial bus system, wherein the method using a transmitting/receiving device, which includes a transmitting module, a receiving module, and a wake-up module, wherein the method comprises the following steps:
transmitting, using the transmitting module, a transmission signal, which is created for communication in the bus system based on a frame, as an analog signal to the bus of the bus system;
receiving, using the receiving module, an analog signal from the bus of the bus system;
generating, using the receiving module, a digital reception signal from the analog signal received from the bus;
waking up, using the wake-up module, the subscriber station after the subscriber station has been put to sleep to save energy;
wherein the wake-up module serially carries out at least two different evaluations to decide whether or not the digital reception signal corresponds to a wake-up frame which gives instructions to activate the transmitting module to wake up the subscriber station; and
wherein, for the decision as to whether or not the digital reception signal corresponds to the wake-up frame, the wake-up module decodes the digital reception signal in a predetermined region according to a different format than the predetermined region was encoded in the transmission signal.
